(19) United States
(12) Patent Application Publication
(10) Pub. No.: US 2013/0073720 A1
(43) Pub. Date: Mar. 21, 2013

(54) METHOD AND APPARATUS FOR PROVIDING INFORMATION REGARDING A DEVICE

(71) Applicants: Hyun-suk MIN, Suwon-si (KR); Young-sik LEE, Suwon-si (KR); Dae-yeon JEONG, Hwaseong-si (KR)

(72) Inventors: Hyun-suk MIN, Suwon-si (KR); Young-sik LEE, Suwon-si (KR); Dae-yeon JEONG, Hwaseong-si (KR)

(73) Assignee: Samsung Electronics Co., Ltd., Gyeonggi-do (KR)

(21) Appl. No.: 13/614,404

(22) Filed: Sep. 13, 2012

(30) Foreign Application Priority Data
Sep. 21, 2011 (KR) 10-2011-0095230

(51) Int. Cl. G06F 15/173

(52) U.S. Cl. 709/224

(57) ABSTRACT

A method and apparatus of providing information regarding at least one device is provided. The method includes receiving location information and service information from an external device; and transmitting information regarding at least one device capable of providing a service based on according to the service information in a predetermined region based on the location information to the external device.

### PRIORITY

This application claims priority under 35 U.S.C. §119(a) to Korean Patent Application No. 10-2011-0095230, filed on Sep. 21, 2011 in the Korean Intellectual Property Office, the entire disclosure of which is incorporated herein by reference.

### BACKGROUND OF THE INVENTION

1. Field of the Invention

The present invention relates generally to providing information and a service based on provided information, and more particularly, providing information regarding a device based on a location chosen by a user.

2. Description of the Related Art

In order to use a service provided from a device placed in a location chosen by a user, the user should find the device providing the service while moving in a region based on the location chosen by the user, and directly control the found device.

For example, in order to print a document stored in a mobile device in a region A, the user needs to find a printer in region A. If the user finds the printer, the user needs to check whether or not the printer can print the document transmitted from the mobile device. If the found printer can print the document transmitted from the mobile device, the user can then control the mobile device and the printer respectively and obtain a printout. If the found printer cannot print the document transmitted from the mobile device, the user need to move in the region A to find another printer or needs to move to another region if region A has no printer able to print the document transmitted from the mobile device.

Thus, it can be time consuming and inefficient to use a user service provided by a device placed in a location chosen by the user.

### SUMMARY OF THE INVENTION

Accordingly, the present invention has been made to solve the above-stated problems occurring in the prior art, and an aspect of the present invention provides a method and apparatus for providing information regarding devices based on a location chosen by a user in order that the user can use a service provided from the devices based on the location quickly and conveniently.

According to an aspect of the present invention, provided a method of providing information regarding at least one device is provided. The method includes receiving, from an external device, location information and service information; and transmitting, to the external device, information regarding at least one device capable of providing a service based on the service information in a predetermined region based on the location information.

According to another aspect of the present invention, A method of providing information regarding at least one device in a user terminal is provided. The method includes transmitting, to an external device, location information and service information; receiving, from the external device, information regarding the at least one device capable of providing a service based on the service information in a predetermined region based on the location information; and outputting the received information regarding the at least one device.

According to another aspect of the present invention, a service method is provided. The method includes receiving location information and service information from an external device; finding at least one device capable of providing a service based on the service information in a predetermined region based on the location information; transmitting, to the external device, information regarding the found at least one device; receiving, from the external device, service selection information based on the transmitted information regarding the at least one device; and controlling the at least one device capable of providing the service based on the received service selection information.

According to another aspect of the present invention, a service method performed in a user terminal is provided. The method includes transmitting location information and service information to an external device; receiving, from the external device, information regarding at least one device capable of providing a service based on the service information in a predetermined region based on the location information; outputting the received information regarding the at least one device; and transmitting, to the external device, service selection information input based on the output information regarding the at least one device.

According to another aspect of the present invention, service method performed by a user terminal is provided. The method includes generating location information and service information; finding at least one device capable of providing a service based on the service information in a predetermined region based on the location information; outputting the found information regarding the at least one device.

According to another aspect of the present invention, service method in a user terminal is provided. The method includes generating location information and service information; finding at least one device capable of providing a service based on the service information in a predetermined region based on the location information; outputting information regarding the found at least one device; generating service selection information based on the output information; and controlling the at least one device capable of providing the service based on the generated service selection information.

According to another aspect of the present invention, a computer readable recording medium storing a program for executing a method of providing an external device with information regarding at least one device is provided. The method includes receiving, from the external device, location information and service information; and transmitting, to the external device, information regarding at least one device capable of providing a service based on the service information in a predetermined region based on the location information.

According to another aspect of the present invention, a user terminal is provided. The terminal includes a user interface unit for interfacing with a user; a communication unit for communicating with an external device; and a processor for executing a program, wherein the program comprises: receiving, from the user interface unit, service information; transmitting, to the external device, location information and the service information, through the communication unit; receiving, from the external device, information regarding at least one device capable of providing a service based on the service information, through the communication unit; and outputting the information regarding the at least one device to the user interface unit.

According to another aspect of the present invention, a service apparatus is provided. The apparatus includes a communication unit for communicating with an external device; and a processor for executing a program, wherein the program comprises: receiving, from the external device, location information and service information, through the communication unit; transmitting, to the external device, information regarding at least one device capable of providing a service according to the service information in a predetermined region based on the location information, through the communication unit; receiving, from the external device, service selection information based on the transmitted information regarding the at least one device; and controlling the at least one device capable of providing the service based on the service selection information through the communication unit.

According to another aspect of the present invention is provided. The user terminal includes a user interface unit for interfacing with a user; and a processor for executing at least one program, wherein the program comprises: receiving, from the user interface unit, service information; and outputting, to the user interface unit, information regarding at least one device capable of providing a service based on the service information in a predetermined region based on the location information.

According to another aspect of the present invention, a user terminal is provided. The terminal includes a user interface unit for interfacing with a user; a communication unit for communicating with an external device; and a processor for executing a program, wherein the program comprises: receiving, from the user interface unit, service information; outputting, to the user interface unit, information regarding at least one device capable of providing a service based on the service information in a predetermined region based on the location information; receiving, through the user interface unit, service selection information; and controlling, through the communication unit, the at least one device capable of providing the service based on the received service selection information.

### BRIEF DESCRIPTION OF THE DRAWINGS

The above and other aspects, features and advantages of the present invention will become more apparent by describing in detail embodiments thereof with reference to the attached drawings in which:

FIG. 1 is a block diagram illustrating an information-providing system including an information-providing apparatus and a user terminal according to an embodiment of the present invention;

FIG. 2 is a flowchart illustrating an information-providing method performed in a user terminal according to an embodiment of the present invention;

FIG. 3 is a diagram illustrating providing information regarding a device capable of providing a service according to service information in a predetermined region based on a current location of a user terminal;

FIG. 4 is a diagram illustrating screens for providing information regarding a device based on a specific location other than a current location of a user terminal;

FIG. 5 is a table of information illustrating devices installed in a predetermined region based on a first location;

FIG. 6 is a flowchart illustrating an information-providing method according to an embodiment of the present invention;

FIG. 7 is a flowchart illustrating steps between a user terminal and an information-providing apparatus according to an embodiment of the present invention;

FIG. 8 is a block diagram illustrating an information-providing system including a server and a user terminal according to another embodiment of the present invention;

FIG. 9 is a flowchart illustrating an information-providing method according to another embodiment of the present invention;

FIG. 10 is a flowchart illustrating steps between a user terminal and a server in the information-providing method of FIG. 9;

FIG. 11 is a flowchart illustrating a service method performed by a server according to an embodiment of the present invention;

FIG. 12 is a flowchart illustrating a service method performed by a user terminal according to an embodiment of the present invention;

FIG. 13 is a flowchart illustrating steps between a user terminal and a server in the service method of FIG. 11;

FIG. 14 is a block diagram illustrating an information-providing system including an information-providing apparatus according to another embodiment of the present invention;

FIG. 15 is a flowchart illustrating an information-providing method according to another embodiment of the present invention;

FIG. 16 is a flowchart illustrating an information-providing method according to another embodiment of the present invention;

FIG. 17 is a flowchart illustrating a service method performed by a user terminal according to another embodiment of the present invention; and

FIG. 18 is a flowchart illustrating a service method with respect to FIGS. 14 and 17 according to another embodiment of the present invention.

### DETAILED DESCRIPTION OF EMBODIMENTS OF THE PRESENT INVENTION

The present invention will now be described more fully with reference to the accompanying drawings, in which embodiments of the invention are shown.

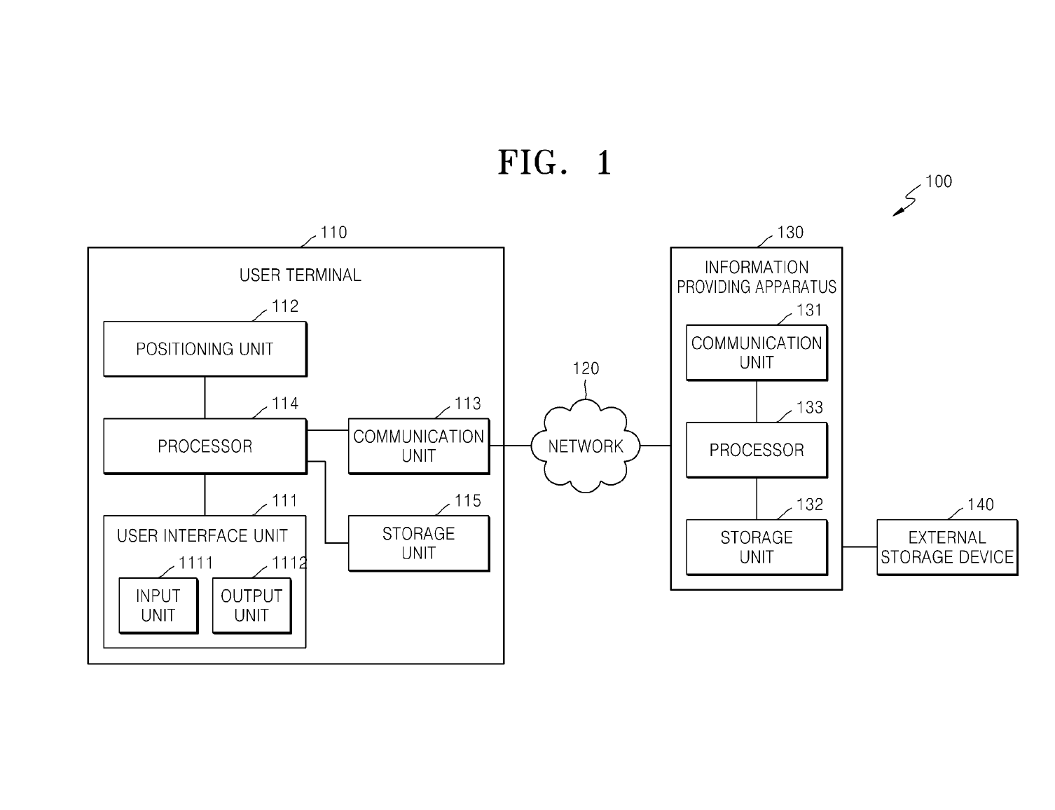

FIG. 1 is a block diagram illustrating an information-providing system 100 including an information-providing apparatus 130 and a user terminal 110 according to an embodiment of the present invention.

Referring to FIG. 1, the information-providing system 100 includes the user terminal 110, a network 120, the information-providing apparatus 130, and an external storage device 140. Although one user terminal 110 and the information-providing apparatus 130 are connected to one another over the network 120 in FIG. 1, a plurality of user terminals including the user terminal 110 is connected to the information-providing apparatus 130 over the network 120.

The user terminal 110 is referred to as a device, an equipment, an apparatus, or a client device. The user terminal 110 is referred to as an external device, an external apparatus or external equipment with respect to the information-providing apparatus 130.

The user terminal 110 includes a device or a mobile device capable of wired/wireless communication. The mobile device includes a portable phone, an MP3 player, a smart phone, a navigation device, and a personal digital assistant (PDA).

The user terminal 110 of FIG. 1 transmits location information and service information to the information-providing apparatus 130 in order to receive information regarding at least one device from the information-providing apparatus 130, and outputs the information regarding the at least one device received from the information-providing apparatus 130. The at least one device includes a device installed or placed in a location where a user using the user terminal 110 wants.

The user terminal 110 of FIG. 1 includes a user interface unit 111, a positioning unit 112, a communication unit 113, a processor 114, and a storage unit 115.

The user interface unit 111 inputs data or information that a user wants to input, and output data or information that a user can see and/or hear. The user interface unit 111 includes an input unit 1111 and an output unit 1112. According to an embodiment of the present invention, the data or information input through the user interface unit 111 includes location information and service information desired by the user.

The location information input through the user interface unit 111 includes current location information of the user terminal 110 and location information unrelated to a current location of the user terminal 110. The location information input through the user interface unit 111 is input based on map data or previously registered location information. When the location information is input based on the map data, the input location information includes coordinate information. The previously registered location information includes location information, for example, a house, an office, a place that the user has visited, and the like. The previously registered location information includes the coordinate information. The current location information of the user terminal 110 may not be input through the user interface unit 111. When the service information is input through the user interface unit 111, the current location information of the user terminal 110 is obtained by the positioning unit 112, as described below. If a location chosen by the user is a specific floor of a multiple story building, the location information includes information regarding the specific floor. The location information unrelated to the current location includes location information excluding the current location information. The location information excluding the current location information includes location information that is not previously registered.

The service information includes information regarding a service type of a service desired by the user. For example, the service information includes service type information such as printing, scanning, temperature control, illumination control, Internet access, and device and power status check or service category information.

The positioning unit 112 is a module or an element or a means for measuring the current location of the user terminal 110. The positioning unit 112 is configured to measure current location of the user terminal 110 based on triangulation such as Angle of Arrival (AoA), Time of Arrival (ToA), Time Difference of Arrival (TdoA), and the like, cell IDentification (ID) positioning, enhanced Cell ID positioning, finger printing, a Global Positioning System (GPS), an Assisted GPS (AGPS), a Differential Global Positioning System (DGPS), Wireless Fidelity (Wi-Fi), infrared ray, ultrasonic waves, Radio Frequency IDentification (RFID), and Bluetooth. The positioning unit 112 includes a plurality of units based on a plurality of location-measuring methods so as to selectively use different location-measuring methods. If the positioning unit 112 includes a plurality of units based on a plurality of location-measuring methods, the user interface unit 111 inputs information to select location-measuring methods.

The communication unit 113 transmits and receives data or information to and from the information-providing apparatus 130 over the network 120. The communication unit 113 transmits and receive the data or information in a signal form to and from the information-providing apparatus 130 over the network 120. For example, if the network 120 is a mobile communication-based network, the communication unit 113 is configured to transmit and receive data or information based on mobile communication such as Code Division Multiple Access (CDMA), Global System for Mobile communication (GSM), Time Division Multiple Access (TDMA), Third Generation (3G), fourth Generation (4G), or Personal Communication System (PCS). If the network 120 is a near distance wireless communication-based network, the communication unit 113 is configured to transmit and receive data or information based on near distance wireless communication such as Wi-Fi, Bluetooth, RF-ID, LAN, and the like. If the network 120 is a wired communication-based network, the communication unit 113 is configured to transmit and receive data or information based on wired communication such as IEEE 1394, Phone Network Alliance (Home PNA), Power Line Communication (PLC), and the like.

The storage unit 115 stores a program and data necessary for executing an information-providing method according to embodiments of the present invention. The data stored in the storage unit 115 includes previously stored location information and the current location information of the user terminal 110 obtained by the positioning unit 112.

The processor 114 loads the program for executing an information-providing method according to embodiments of the present invention stored in the storage unit 115, transmits the location information and the service information to the information-providing apparatus 130, outputs the information regarding the device received from the information-providing apparatus 130 through the user interface unit 111, and provides the information regarding the device capable of providing a service regarding the service information in a predetermined region based on a location chosen by the user. The location chosen by the user is adjacent to the user terminal 110. The processor 114 executes at least one program for an information-providing method according to embodiments of the present invention.

The predetermined region is defined as a space based on the location chosen by the user. For example, if the location chosen by the user is the 6^{th} floor of the Empire State Building, all regions of the 6^{th} floor of the Empire State Building are the predetermined region. If the 6^{th} floor of the Empire State Building is registered as location information such as an office 1, the location information chosen by the user is input as the office 1. If the 6^{th} floor of the Empire State Building has a large area, the predetermined region is defined as a region determined according to a previously set distance from the location chosen by the user. The predetermined region is not limited to being indoors.

The predetermined region is defined as a region having a radius of the previously set distance from the location chosen by the user as a radius. If the predetermined region is the region within a radius of the previously set distance, the predetermined region includes a region of a corresponding floor, or the predetermined region includes a partial region of another floor. For example, when some point on the 6^{th} floor of the Empire State Building is a center point of the location chosen by the user, a region of the 6^{th} floor of the Empire State Building among the region having the radius of the previously set distance is set as the predetermined region, or partial regions of 5^{th} and 7^{th} floors of the Empire State Building and the region of the 6^{th} floor of the Empire State Building is included in the predetermined region. As described above, map data or map information (“map data”) of a building is used to set the predetermined region.

If the location chosen by the user is a house, the predetermined region is the whole house. If the house has multiple stories, a floor corresponding to floor information included in the location information desired by the user is the predetermined region, or all multiple stories is included in the predetermined region. The predetermined region is changed according to a change in the location information. The location information used to set the predetermined region includes map data of a corresponding building. If the location information includes the map data of the corresponding building, a desired floor or room of the corresponding building is selected as the predetermined region based on the map data of the corresponding building. A previously registered point based on a current location such as bookmark is set as the predetermined region.

If the service information is only input through the user interface unit 11, the processor 114 transmits the current location information of the user terminal 110 measured by the positioning unit 112 and the input service information to the information-providing apparatus 130 through the communication unit 113.

If the location information and the service information are input through the user interface unit 111, the processor 114 transmits the input location information and service information to the information-providing apparatus 130 through the communication unit 113. In this regard, the input location information is the current location information of the user terminal 110 described above or location information excluding the current location of the user terminal 110 described above. The current location information input through the user interface unit 111 is information used to select the current location information measured by the positioning unit 112, other than coordinate information regarding the current location, as the location information.

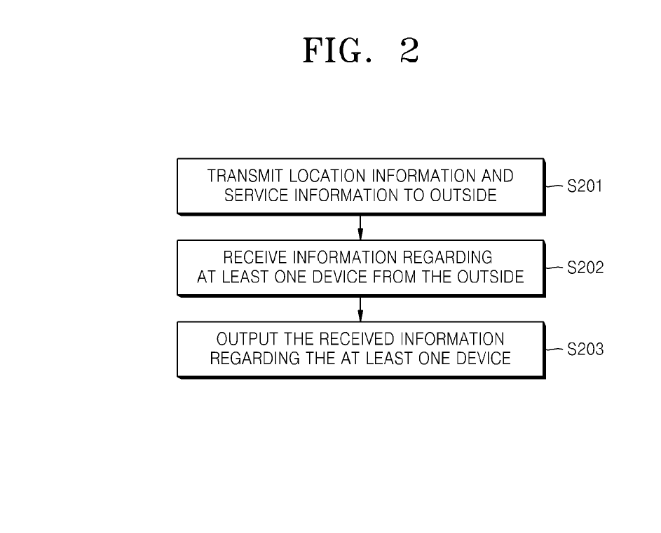

The processor 114 of FIG. 1 operates as shown in FIG. 2. FIG. 2 is a flowchart illustrating an information-providing method performed in a user terminal according to an embodiment of the present invention.

Referring to FIG. 2, the processor 114 transmits at least one piece of the location information input through the user interface unit 111 and the location information obtained by the positioning unit 112, and the service information input through the user interface unit 111 to the information-providing apparatus 130 through the communication unit 113 in step S201.

If the processor 1140 receives information regarding a device capable of providing a service according to the service information among devices installed or placed in a predetermined region based on the location information received from the information-providing apparatus 130 in step S202, the processor 114 outputs the received information regarding the device through the user interface unit 111. The output information regarding the device is displayed through the output unit 1112 or is output as an audio signal in step S203.

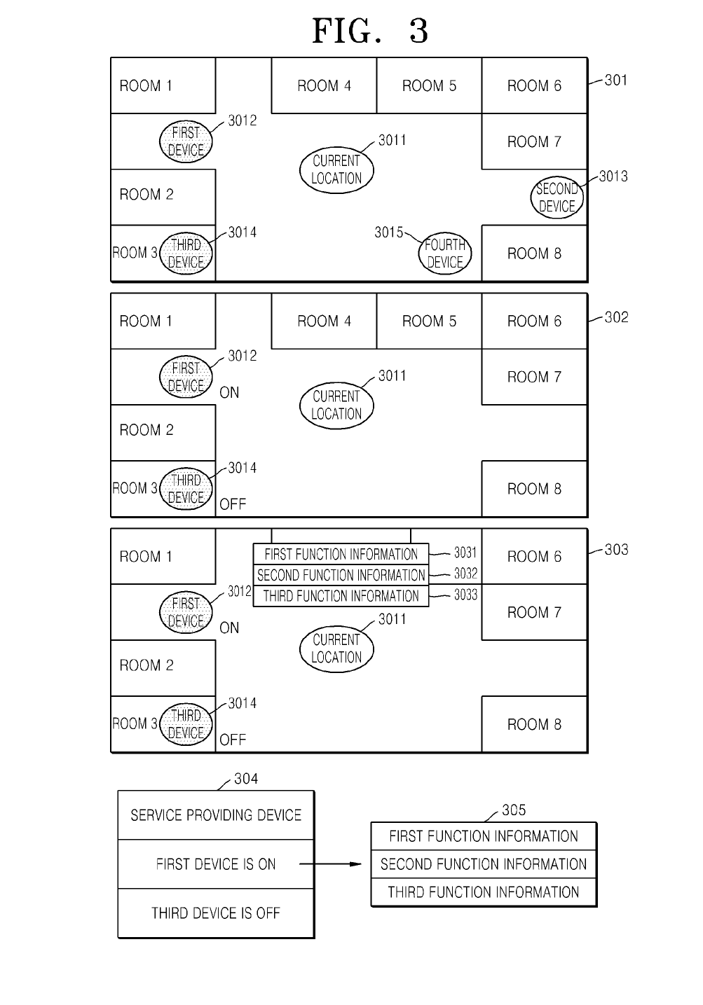

For example, if the location information transmitted to the information-providing apparatus 130 is current location information, the information regarding the device output to the user interface unit 111 in step S203 is displayed as shown in 302 of FIG. 3.

FIG. 3 is a diagram illustrating providing information regarding devices capable of providing a service according to service information in a predetermined region based on a current location of the user terminal 110. As shown in 301, when the current location of the user terminal 110 is 3011, the predetermined region based on the current location is in 301, first through fourth devices 3012-3015 are installed in the predetermined region 301, and the first and third devices 3012 and 3014 provide the service according to service information, current location information of the user terminal 110 and locations where the first and third devices 3012 and 3014 are installed is output on a screen 302 through the user interface unit 111. The screen 302 may also display current status information of the first and third devices 3012 and 3014. As shown in 302, the first device 3012 is powered on, and the third device 3014 is powered off. Although the current status information is displayed at locations adjacent to the corresponding devices in a text form as shown in 302, the current status information is displayed in a balloon form.

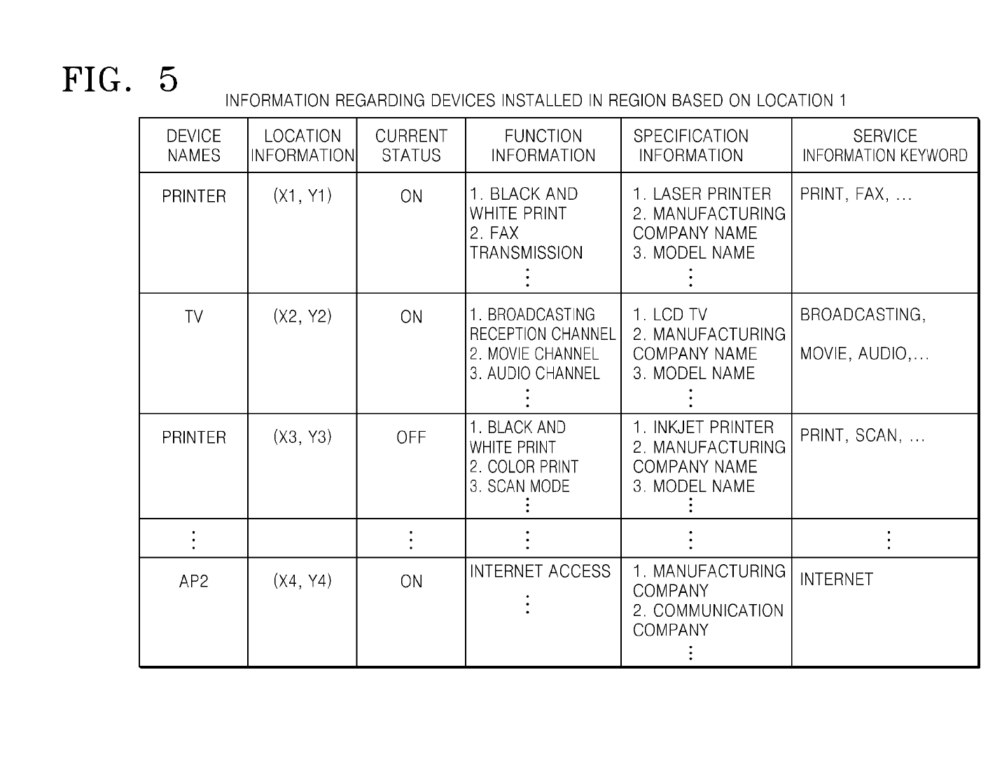

If the screen 302 is output through the output unit 1112 of the user interface unit 111, and the first device 3012 is selected based on the output screen 302, the processor 114 displays function information provided by the first device 3012 in a popup window as shown in 303. First through third function information 3031-3033 shown in 303 are provided by the first device 3012 and includes function information such as a white and black print, a color print, a scan mode, and the like if the first device 3012 is a printer as will be shown in FIG. 5. The function information provided by a device is not displayed in the popup window as shown in 303 and is displayed using a separate empty space on a screen when the device is selected.

If the information regarding the device received from the information-providing apparatus 130 is in text form, the information regarding the device output in step S203 is output as shown in 304. When the received information regarding the device is output as shown in 304, if the first device 3012 is selected through the user interface unit 111, the output screen is changed to a screen 305 including function information regarding the first device 3012 or the screen 305 is displayed on the screen 304 in the popup window.

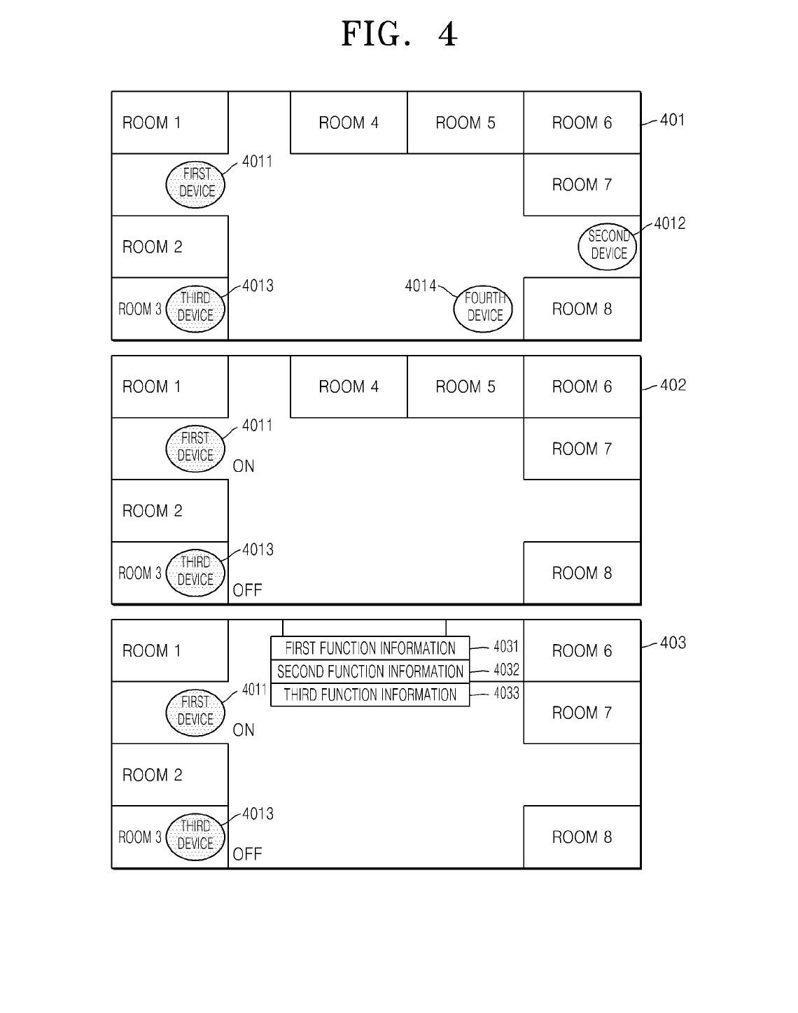

However, if information regarding a specific location other than the current location 3011 is input through the user interface unit 111, and the predetermined region based on the location information is the same as 301 and the user terminal 110 is not installed or placed in the predetermined region, a screen of the predetermined region output through the output unit 1112 of the user interface unit 111 is a screen in which first through fourth devices 4011-4014 are installed as shown in 401 of FIG. 4.

FIG. 4 is a diagram of screens for providing information regarding a device based on a specific location other than a current location of the user terminal 110. Referring to FIG. 4, when the device is installed in a predetermined region based on location information as shown in 301 of FIG. 3, the current location of the user terminal 110 is not included in the predetermined region 301, and the first and third devices 4011 and 4013 provide services according to service information, a screen 402 is output through the output unit 1112 of the user interface unit 111.

In the screen 402 output through the output unit 1112 of the user interface unit 111, if the first device 4011 is selected through the user interface unit 111, information based on function information of the first device 4011 is displayed as shown in 403. Accordingly, a user is informed of a service content provided by the first device 4011. Thus, if the user uses the service provided by the first device 4011, the user controls the first device 4011 by moving to a location where the first device 4011 is installed or by using a server 830 that will be described later.

When the screen 402 is output through the output unit 1112 of the user interface unit 111, if a selection signal of the first device 4011 is input through the user interface unit 111, a pop-up window including first through third function information 4031-4033 is displayed on the user interface unit 111. If the third device 4013 that is powered off is selected through the user interface unit 111, function information of the third device 4013 includes function information used to power the third device 4013 on.

The network 120 is configured as a wired or wireless network as described with respect to the communication unit 113. If the network 120 is the wireless network, the network 120 is configured as a network capable of wireless data communication such as Wi-Fi, 3G, 4G, Wideband code division Multiple Access (WCMA), RFID, Bluetooth, and the like.

The information-providing apparatus 130 of FIG. 1 is referred to as a server providing information regarding a device capable of providing a service according to service information in a predetermined region based on a location chosen by a user according to an embodiment of the present invention. The information-providing apparatus 130 includes a communication unit 131, a storage unit 132, and a processor 133.

The communication unit 131 is connected to the user terminal 110 over the network 120 to transmit and receive data or information, and connected to the external storage device 140 to read information stored in the external storage device 140. The communication unit 131 is configured to include a unit for interfacing with the network 120 in order to transmit and receive the data or information to and from the user terminal 110 over the network 120 and a unit for reading information or data from the external storage device 140. The unit for interfacing with the network 120 is determined according to communication specification of the network 120 as described in the communication unit 113. The unit for reading information or data from the external storage device 140 is configured to read information or data by wire or wirelessly.

The storage unit 132 stores a program for executing an embodiment of the present invention and data. The data stored in the storage unit 132 includes information regarding a device installed or placed in a predetermined region based on location information. That is, the storage 132 includes information regarding a device installed or placed in a predetermined region based on location 1 shown in FIG. 5.

FIG. 5 is a table of information illustrating devices installed or placed in a predetermined region based on a location 1. Referring to FIG. 5, the information regarding devices includes names of devices installed or placed in the predetermined region based on the location 1, locations and current statuses of devices, function information, specification information, and a service information keyword. Devices installed or placed in the location 1 include at least two printers, a TV, and two access points. The service information keyword is information used to detect devices based on service information, and is referred to as the service type information or service category information as serviceable information based on function information of a corresponding device.

The data stored in the external storage device 140 includes information regarding a device installed or placed in the predetermined region based on location information like the storage unit 132. However, the data stored in the external storage device 140 includes information regarding a device installed or placed in a location other than a location where information regarding a device is stored in the storage unit 132 or information regarding devices installed or placed in a location where information regarding a device stored in the storage unit 132 is stored and in a location other than the location where information regarding the device stored in the storage unit 132 is stored. The information regarding the device is classified and stored according to predetermined region based on the location. Thus, the processor 133 reads the information regarding the device based on location information from at least one of the storage unit 132 and the external storage device 140 based on received location information. The processor 133 determines the predetermined region based on the location information. For example, the processor 132 determines the predetermined region by using a previously set range and the location information, and reads the information regarding the device from at least one of the storage unit 132 and the external storage device 140 based on the determined predetermined region. The previously set rage is determined based on the radium or distance described in the embodiments described above.

The processor 133 detects information regarding a device capable of providing a service according to service information from the information regarding the devices read from at least one of the storage unit 132 and the external storage device 140. When data is read from the storage unit 132 or the external storage device 140, the processor 133 reads information regarding a device satisfying the location information and the service information.

If the location information and the service information are received through the communication unit 131, the processor 133 transmits information regarding a device based on the received location information and service information to the user terminal 110 through the communication unit 131.

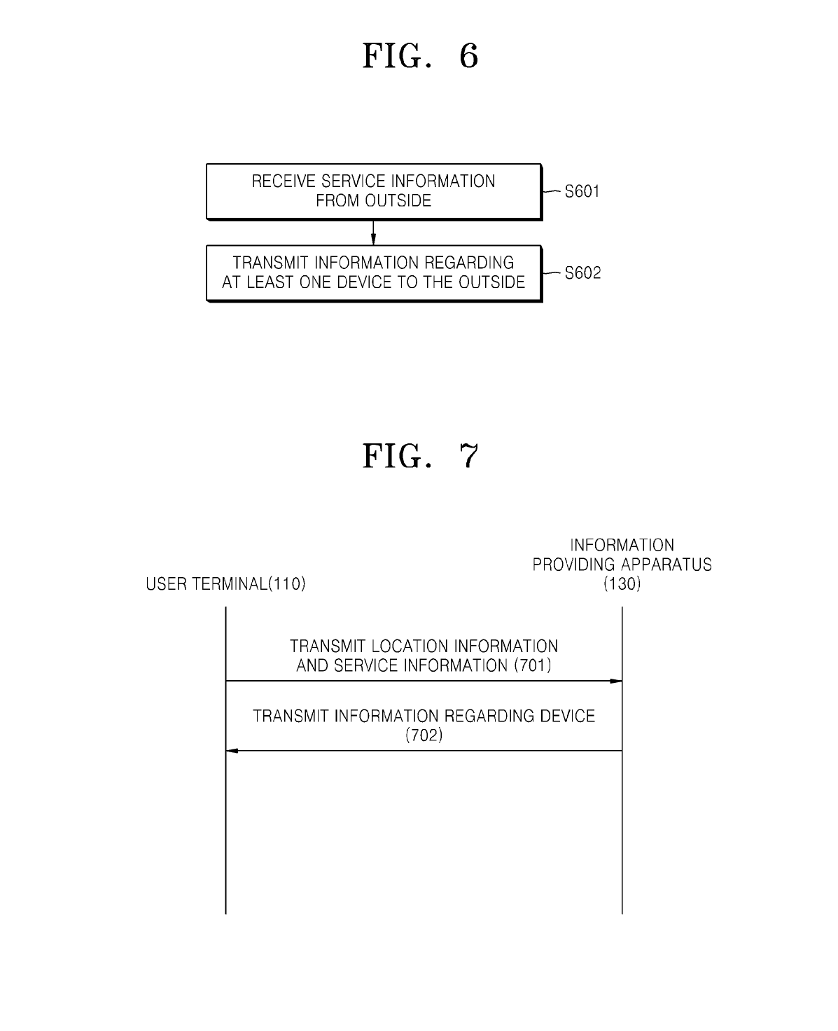

The processor 133 performs steps as shown in FIG. 6. FIG. 6 is a flowchart illustrating an information-providing method according to an embodiment of the present invention. Referring to FIG. 6, when the processor 133 receives location information and service information from the user terminal 110 in step S601, the processor 133 transmits information regarding at least one device capable of providing a service according to the service information in a predetermined region based on the received location information in step S602.

That is, the processor 133 reads information regarding a device installed or placed in a predetermined region based on the location information from at least one of the storage unit 132 and the external storage device 140 by using the received location information. The processor 133 detects Information regarding the device capable of providing the service according to the service information from the read information regarding the device and transmits to the user terminal 110. The information regarding the device capable of providing the service according to the service information is detected by using the service information keyword based on the function information of devices shown in FIG. 5.

A flowchart between the user terminal 110 and the information-providing apparatus 130 based on FIGS. 1, 2, and 6 is shown in FIG. 7. Referring to FIG. 7, when the user terminal 110 transmits location information and service information to the information-providing apparatus 130 in step 701, the information-providing apparatus 130 transmits information regarding a device based on the received location information and service information to the user terminal 110 in step 702. The information-providing apparatus 130 is configured to set a predetermined region based on the received location information and detect information regarding a device providing a service according to the service information by using information regarding a device installed or placed in the set predetermined region in order to transmit the information regarding the device based on the received location information and service information to the user terminal 110.

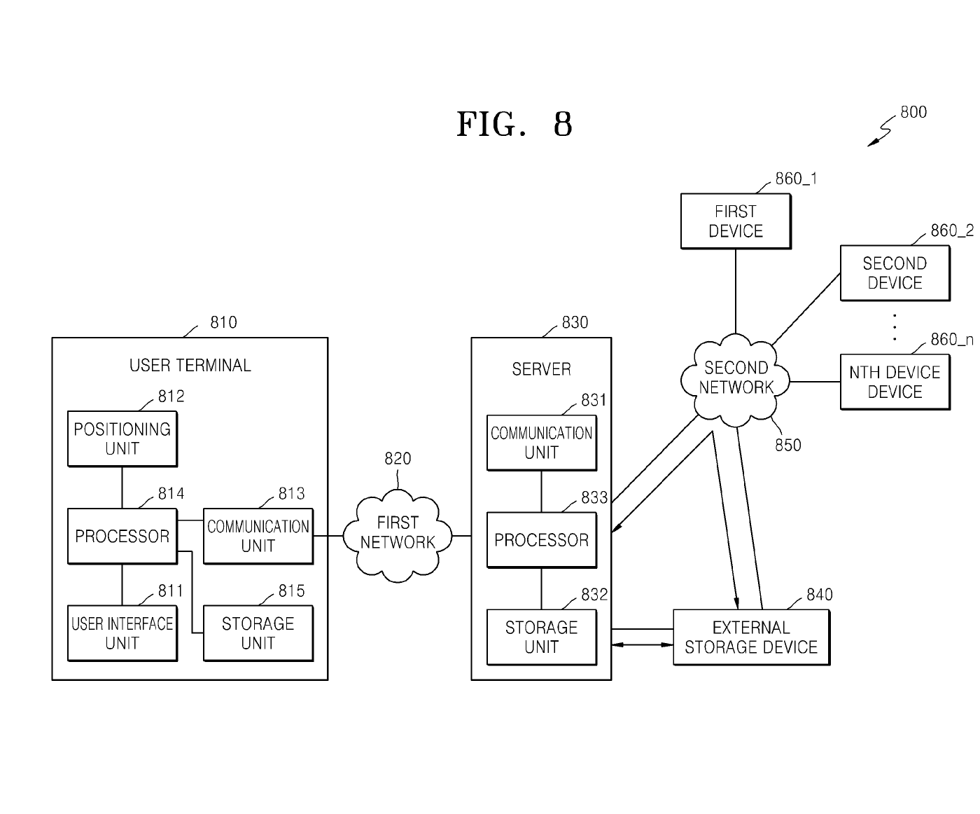

FIG. 8 is a block diagram of an information-providing system 800 including a server 830 and a user terminal 810 according to another embodiment of the present invention. Referring to FIG. 8, the information-providing system 800 includes the user terminal 810, a first network 820, the server 830, an external storage device 840, a second network 850, and first through nth devices 860_1-860_{—}n.

The user terminal 810 and the first network 820 of FIG. 8 are configured in a similar manner to the user terminal 110 and the first network 120 of FIG. 1. Data stored in a storage unit 832 included in the server 830 and the external storage device 840 may also be the same as the data stored in the storage unit 132 and the external storage device 140 of FIG. 1.

A communication unit 831 included in the server 830 is configured to communicate with the first network 820 and the second network 850, and read the data from the external storage device 840. The first network 820 and the second network 850 have the same communication protocol. However, the first network 820 is a near-distance wireless communication network, but the second network 850 is a far-distance wireless communication network. If the first network 820 and the second network 850 use a different communication protocol, the communication unit 831 independently includes a unit for interfacing with the first network 820 and a unit for interfacing with the second network 850.

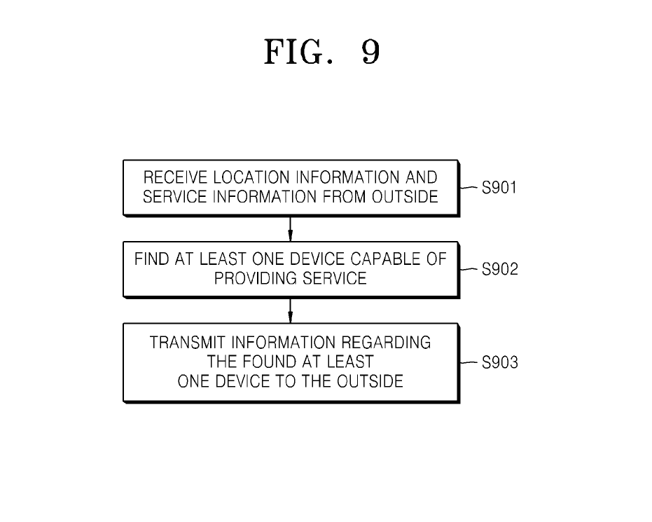

A processor 833 of the server 830 operates as shown in FIG. 9. FIG. 9 is a flowchart illustrating an information-providing method according to another embodiment of the present invention.

Referring to FIG. 9, when the processor 833 receives location information and service information from the user terminal 810 in step S901, the processor 833 finds a device capable of providing a service according to the service information in a predetermined region based on the received location information in step S902. The predetermined region is set as described in FIGS. 1 and 6. The device is found by using at least one piece of data stored in the storage unit 832 or data stored in the external storage device 840. The external storage device 840 is connected to the communication unit 831 by wire, or is wirelessly connected to the communication unit 831 through the second network 850. To find the device in the processor 833 by using the storage unit 832 and the external storage device 840 is referred to a device search. The processor 833 may find the device by communicating with the first through nth devices 860_1-860_{—}n through the second network 850. To find the device by communicating with the first through nth devices 860_1-860_{—}n is performed based on transmitting and receiving data between the communication unit 831 and the first through nth devices 860_1-860_{—}n via Peer-to-Peer (P2P) or periodically updated current status information based on information regarding the first through nth devices 860_1-860_{—}n stored in the storage unit 832. Finding the device includes searching the device.

The processor 833 transmits information regarding the found device to a user terminal 810 in step S903. The information regarding the found device is obtained when finding the device. Accordingly, finding the device is referred to as finding the information regarding the device.

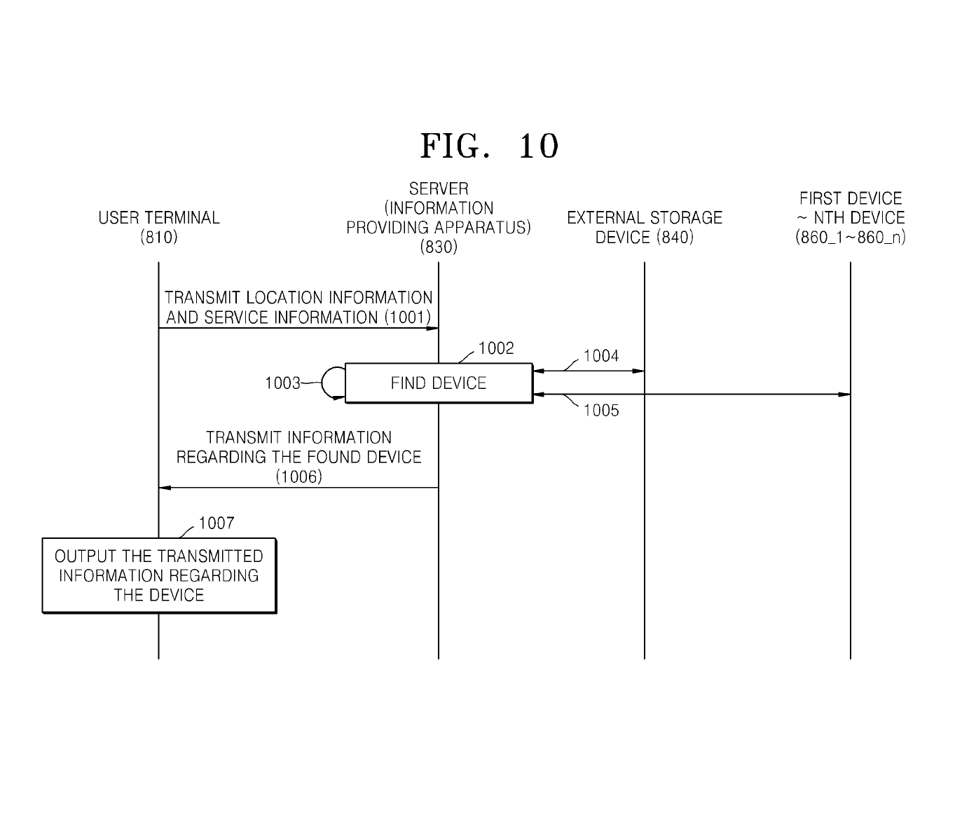

A flowchart between the user terminal 810 and the server 830 based on FIGS. 8 and 9 is shown in FIG. 10. FIG. 10 is a flowchart illustrating steps between the user terminal 810 and the server 830 in the information-providing method of FIG. 9.

Referring to FIG. 10, when the server 830 receives location information and service information from the user terminal 810 in step 1001, the server 830 finds a device based on the received location information and service information in step 1002. The device is found by using at least one of the storage unit 832 of the server 830 and the external storage device 840 in steps 1003 and 1004 or communicating data with the first through nth devices 860_1-860_{—}n in step 1005. The found Information regarding the device is transmitted to the user terminal 810 in step 1006. The server 830 of FIG. 8 is referred to as an information-providing apparatus according to the flowchart illustrated in FIG. 10.

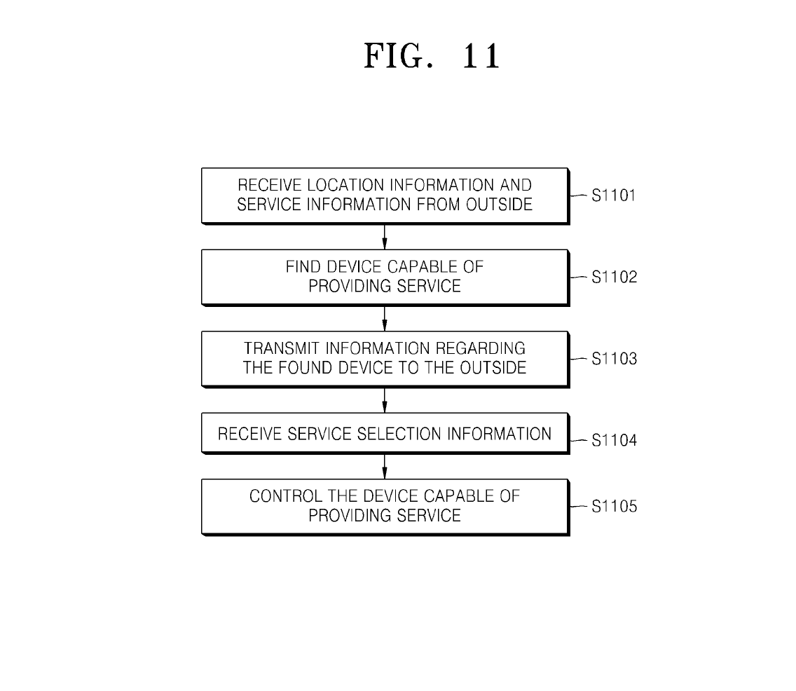

If a signal transmitted from the user terminal 810 requests the information regarding the device based on the location information and the service information, as well as requests for a service based on the received information regarding the device, the server 830 of FIG. 8 is referred to as a service apparatus. If the server 830 is referred to as the service apparatus, the processor 833 operates as shown in FIG. 11. FIG. 11 is a flowchart illustrating a service method according to an embodiment of the present invention.

Referring to FIG. 11, when the processor 833 receives location information and service information from a user terminal 810, the processor 833 finds a device capable of providing a service in a predetermined region based on a location as described in step S902 of FIG. 9 in step S1102. The processor 833 transmits information regarding the found device to the user terminal 810 in step S1103. When service selection information based on the transmitted information regarding the device is received in step S1104, the processor 833 controls the device providing a selected service through the communication unit 831 in step S1105. Thus, a desired service is provided to a user. The service selection information corresponds to the first function information 3031 and 4031 if the user selects the first function information 3031 and 4031 provided by the first devices 3012 and 4011 based on the output function information regarding the device as shown in 303 of FIG. 3 or 403 of FIG. 4.

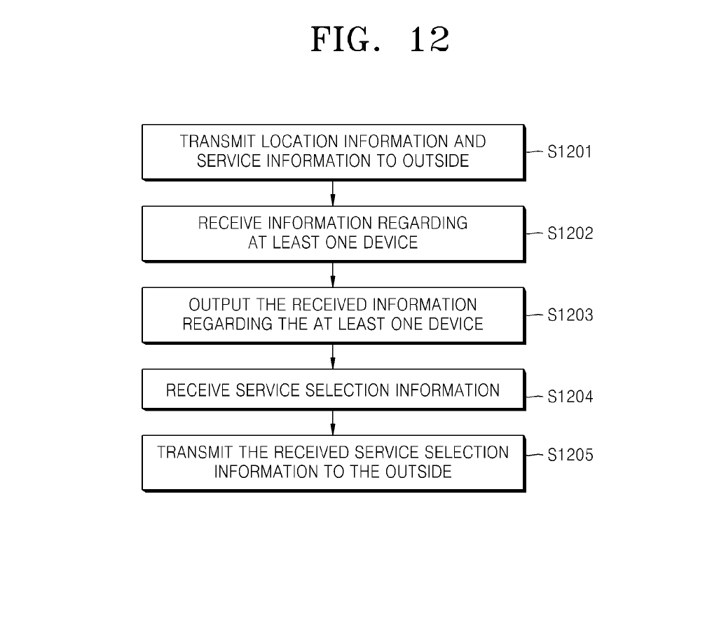

When the processor 833 of the server 830 of FIG. 8 operates as shown in FIG. 11, a processor 814 of the user terminal 810 operates as shown in FIG. 12. FIG. 12 is a flowchart illustrating a service method performed in the user terminal 810 according to another embodiment of the present invention.

Referring to FIG. 12, the user terminal 810 transmits location information and service information to the server 830 in step S1201. When the user terminal 810 receives information regarding at least one device from the server 830 in step S1202, the user terminal 810 outputs the received information regarding the device in step S1203. When the processor 814 receives service selection information through the user interface 811 based on the output information regarding the device in step S1204, the processor 814 transmits the received service selection information to the server 830 in step S1205.

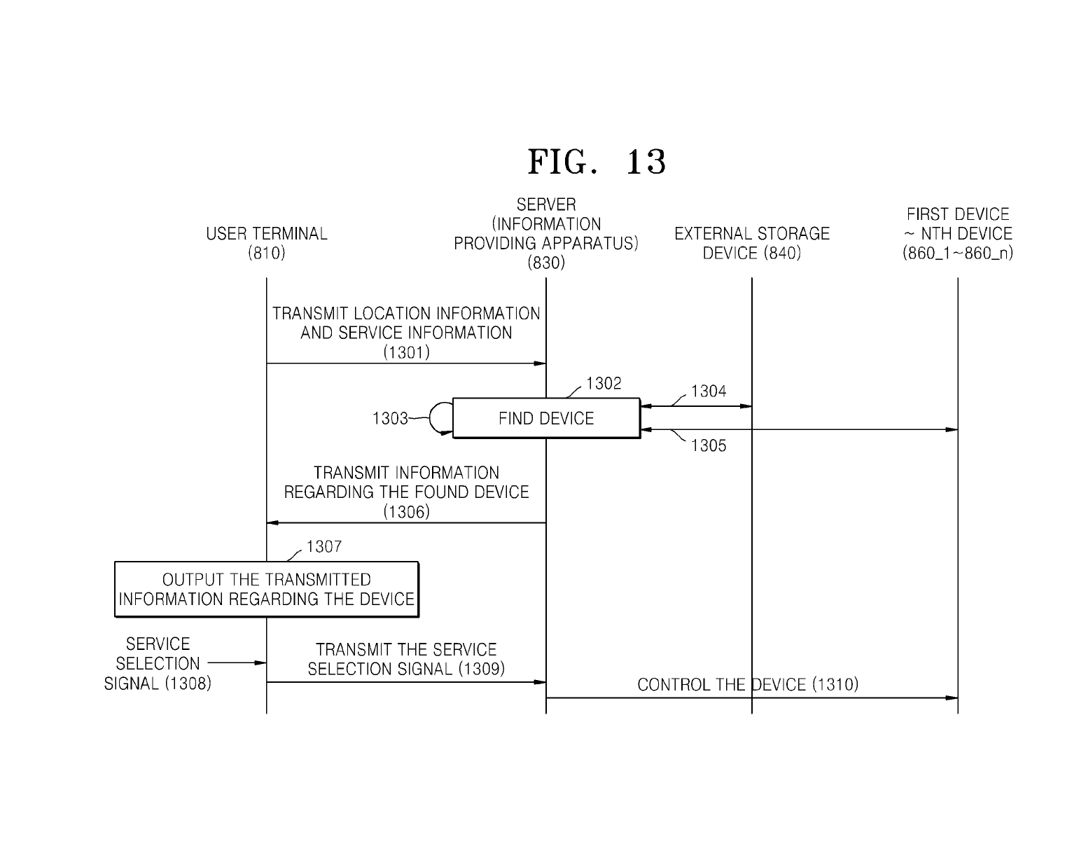

A flowchart illustrating an interaction between the user terminal 810 and the server 830 based on FIGS. 11 and 12 is shown in FIG. 13. Referring to FIG. 13, when the server 830 receives location information and service information from the user terminal 810 in step S1301, the server 830 finds a device capable of providing a service according to the service information in a predetermined region based on the location information in step S1302-S1305. The processor 833 transmits information regarding the found device to the user terminal 810 in step S1306).

The user terminal 810 outputs the information regarding the device in step S1307. When a service selection signal is input based on the output information regarding the device in step S1308, the user terminal 810 transmits the input service selection information to the server 830 in step S1309. The server 830 controls the device capable of providing the service according to the received service selection information in step S1310. Accordingly, a user is provided with a desired service by controlling a device capable of providing a service that the user wants among devices installed or placed in the predetermined region based on a location chosen by the user.

The information-providing apparatus 130 of FIG. 1 and the server 830 of FIG. 8 is referred to as external devices of the user terminals 110 and 810, respectively.

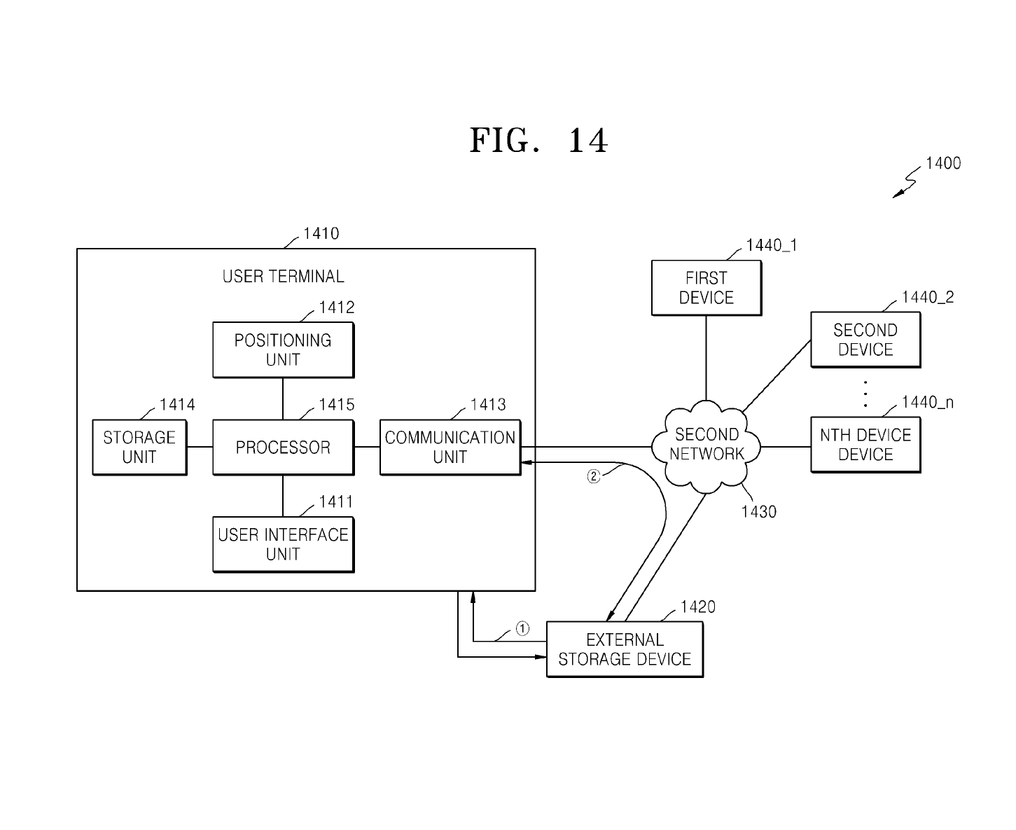

FIG. 14 is a block diagram of an information-providing system including an information-providing apparatus according to another embodiment of the present invention. FIG. 14 is a block diagram of a network including an information-providing apparatus according to an embodiment of the present invention.

In FIG. 14, a user terminal 1410 is used to output information regarding a device capable of providing a service according to service information that a user wants in a predetermined region based on a location chosen by the user.

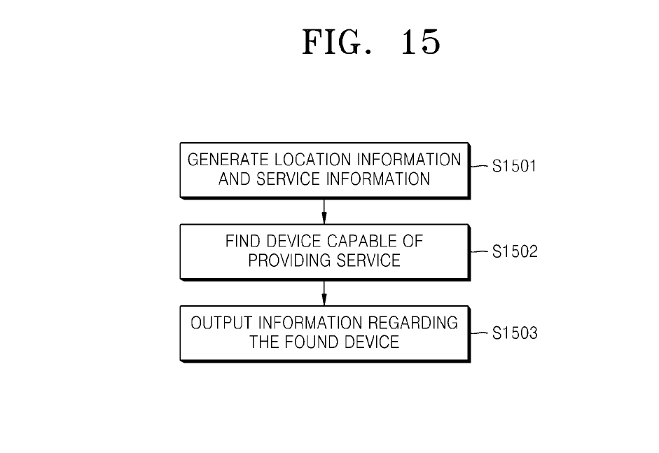

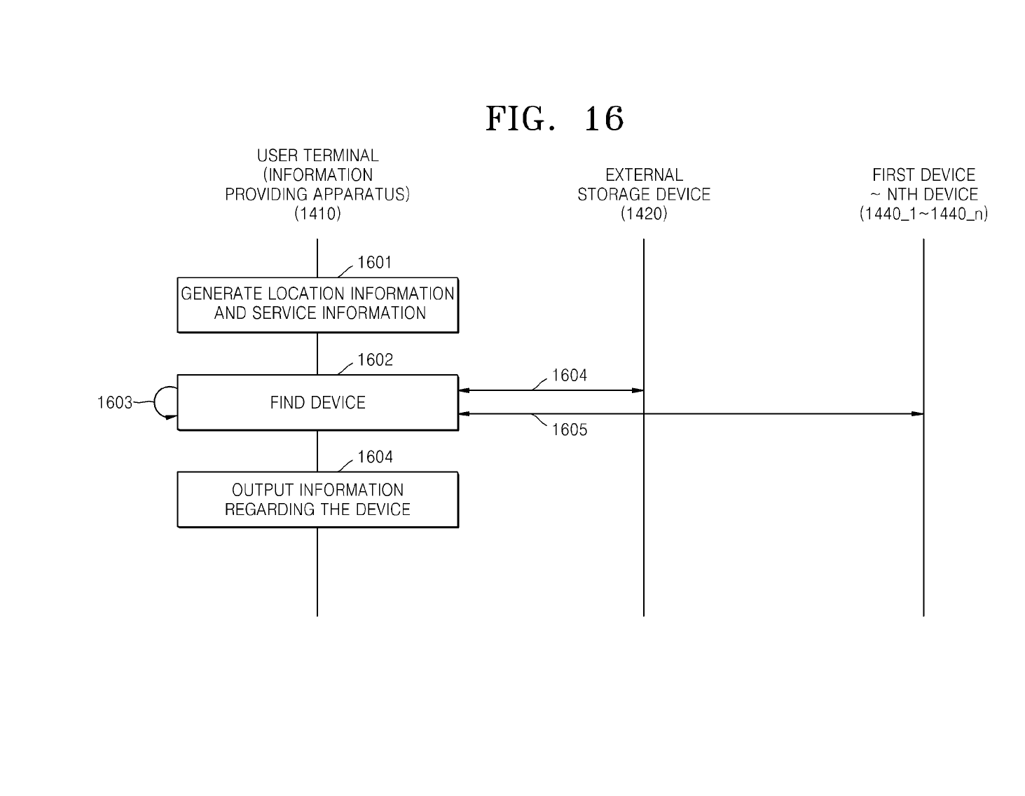

A processor 1415 of the user terminal 1401 operates as shown in FIG. 15. FIG. 15 is a flowchart illustrating an information-providing method according to another embodiment of the present invention.

Referring to FIG. 15, the user terminal 1410 generates location information and service information in step S1501. When the location information is current location information of the user terminal 1410, location information of the user terminal 1410 obtained by the positioning unit 1412 is generated as the location information. However, when the location information is location information input by the user interface unit 1411 of the user terminal 1410, location information input through the user interface unit 1411 is generated as the location information. The service information is generated by information input through the user interface unit 1411. The service information is the same as described in FIG. 5.

The processor 1415 of FIG. 14 finds a device capable of providing a service based on the generated location information and service information in step S1502. The device is found as described in FIG. 8 and step S902 of FIG. 9. The processor 1415 outputs information regarding the device found by using the user terminal 1410 to the user interface unit 1411 in step S1503.

A flowchart of an information-providing method according to another embodiment of the present invention based on FIGS. 14 and 15 is shown in FIG. 16.

Referring to FIG. 16, when the user terminal 1410 generates location information and service information in step S1601, the user terminal 1410 finds a device capable of providing a service according to the service information in a predetermined region based on the location information in step S1602. The device is found by reading information stored in the storage unit 1414 of the user terminal 1401 in step S1603, reading information stored in the external storage device 1420 in step S1604, or communicating with first through nth devices 1440_1-1440_{—}n through the network 1430 in step S1605. When the user terminal 1410 found the device, the user terminal 1410 outputs information regarding the found device through the user interface unit 1411 in step S1606.

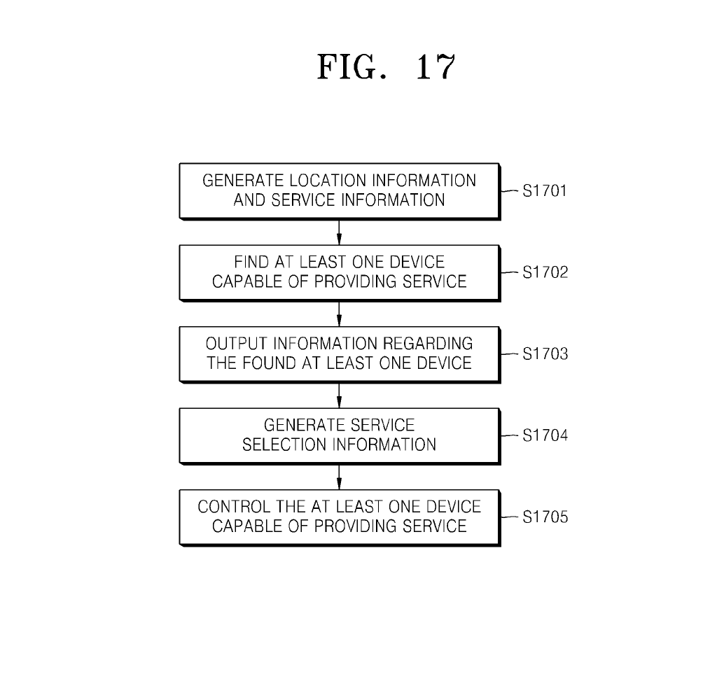

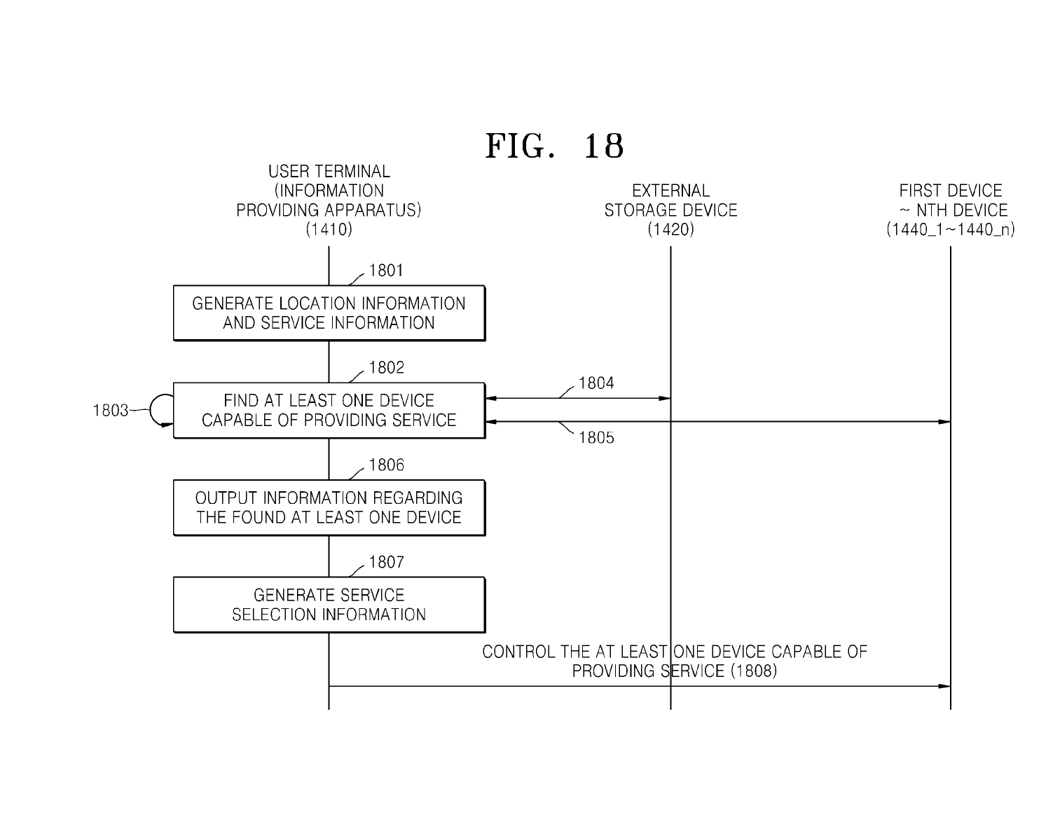

The processor 1415 of the user terminal 1410 of FIG. 14 may provide a user with the service by controlling the device capable of providing the service based on the service selection information input based on the information regarding the device output through the user interface unit 1411 as shown in FIG. 15. That is, the processor 1415 of the user terminal 1410 of FIG. 14 may provide the user with the service by operating as shown in FIG. 17. FIG. 17 is a flowchart illustrating a service method performed in a user terminal according to another embodiment of the present invention.

Referring to FIG. 17, when location information and service information are generated by using the processor 1415 of the user terminal 1410 in step S1701, the processor 1415 finds at least one device capable of providing a service according to the service information from devices installed or placed in a predetermined region based on the location information in step S1702. Then, the processor 1415 outputs Information regarding the found at least one device in step S1703. When service selection information is generated based on the output information in step S1704), the processor 1415 controls the device capable of providing the service based on the generated service selection information in step S1705. FIG. 18 is a flowchart illustrating a service method with respect to FIGS. 14 and 17 according to another embodiment of the present invention.

Referring to FIG. 18, when location information and service information are generated by using the processor 1415 of the user terminal 1410 in step S1801, the processor 1415 finds at least one device capable of providing a service according to the service information from devices installed in a predetermined region based on the location information in step S180). To find the at least one device is performed by using the storage unit 1414 of the user terminal 1401 in step S1803, using the external storage device 1420 in step S180), or communicating with the first through nth devices 1440_1-1440_{—}n through the network 1430 in step S1805 as described in FIG. 16.

The user terminal 1410 outputs information regarding the found at least one device in step S1806. When service selection information is generated based on the output information in step S1807, the processor 1415 controls the at least one device capable of providing the service based on the generated service selection information in step S1808.

The processors 114, 133, 814, 833, and 1415 according to embodiments of the present invention are referred to as executing at least one program for a method according to embodiments of the present invention.

The invention can also be embodied as computer readable codes on a computer readable recording medium. The computer readable recording medium is any data storage device that can store data that can be thereafter read by a computer system. Examples of a computer readable recording medium include Read-Only Memory (ROM), Random-Access Memory (RAM), CD-ROMs, magnetic tapes, floppy disks, optical data storage devices, and the like. The computer readable recording medium can also be distributed over network coupled computer systems so that the computer readable code is stored and executed in a distributed fashion.

While the present invention has been shown and described with reference to certain embodiments and drawings of the portable terminal, it will be understood by those skilled in the art that various changes in form and details is made therein without departing from the spirit and scope of the invention as defined by the appended claims and their equivalents.

What is claimed is:

1. A method of providing information regarding at least one device, the method comprising:
receiving, from an external device, location information and service information; and
transmitting, to the external device, information regarding the at least one device capable of providing a service to the external device based on the service information in a predetermined region based on the location information.

2. The method of claim 1, wherein the information regarding the at least one device comprises at least one piece of current location information of the at least one device, current status information of the at least one device, and function information of the at least one device.

3. The method of claim 1, wherein the information regarding the at least one device transmitted to the external device comprises at least one of map data and text data.

4. The method of claim 1, wherein transmitting the information regarding the at least one device comprises finding the at least one device in the predetermined region.

5. The method of claim 4, wherein finding the at least one device comprises finding the at least one device based on previously stored information.

6. The method of claim 4, wherein finding the at least one device comprises finding the at least one device by communicating with the at least one device using the service information.

7. The method of claim 4, wherein the location information is based on location information input by using the external device.

8. The method of claim 4, wherein the location information is based on a current location of the external device.

9. A method of providing information regarding at least one device in a user terminal, the method comprising:
transmitting, to an external device, location information and service information;
receiving, from the external device, information regarding the at least one device capable of providing a service to the user external based on the service information in a predetermined region based on the location information; and
outputting the received information regarding the at least one device.

10. The method of claim 9, wherein the output information regarding the at least one device comprises at least one piece of current location information of the at least one device, current status information of the at least one device, and function information of the at least one device.

11. The method of claim 9, wherein the location information is based on location information input by using the user terminal.

12. The method of claim 9, wherein the location information is based on a current location of the user terminal.

13. A service method, the method comprising:
receiving location information and service information from an external device;
finding at least one device capable of providing a service to the external device based on the service information in a predetermined region based on the location information;
transmitting, to the external device, information regarding the found at least one device;
receiving, from the external device, service selection information based on the transmitted information regarding the at least one device; and
controlling the at least one device capable of providing the service based on the received service selection information.

14. The method of claim 13, wherein the information regarding the found at least one device comprises at least one piece of current location information of the at least one device, current status information of the at least one device, and function information of the at least one device,
wherein the service selection information is based on at least one piece of current location information of the at least one device, current status information of the at least one device, and function information of the at least one device.

15. The method of claim 13, wherein the location information is based on location information input by using the external device.

16. The method of claim 13, wherein the location information is based on a current location of the external device.

17. A service method performed in a user terminal, the method comprising:
transmitting location information and service information to an external device;
receiving, from the external device, information regarding at least one device capable of providing a service to the user terminal based on the service information in a predetermined region based on the location information;
outputting the received information regarding the at least one device; and
transmitting, to the external device, service selection information input based on the output information regarding the at least one device.

18. The method of claim 17, wherein the output information regarding the at least one device comprises at least one piece of current location information of the at least one device, current status information of the at least one device, and function information of the at least one device,
wherein the service selection information is based on at least one piece of current location information of the at least one device, current status information of the at least one device, and function information of the at least one device.

19. The method of claim 17, wherein the location information is based on location information input by using the user terminal.

20. A service method performed by a user terminal, the method comprising:
generating location information and service information;
finding at least one device capable of providing a service based on the service information in a predetermined region based on the location information;
outputting the found information regarding the at least one device.

21. The method of claim 20, wherein the output information regarding the at least one device comprises at least one piece of current location information of the at least one device, current status information of the at least one device, and function information of the at least one device.

22. The method of claim 20, wherein the location information is based on location information input by using the user terminal.

23. A service method in a user terminal, the method comprising:
generating location information and service information;
finding at least one device capable of providing a service based on the service information in a predetermined region based on the location information;
outputting information regarding the found at least one device;
generating service selection information based on the output information; and
controlling the at least one device capable of providing the service based on the generated service selection information.

24. The method of claim 23, wherein the output information regarding the at least one device comprises at least one piece of current location information of the at least one device, current status information of the at least one device, and function information of the at least one device,
wherein the service selection information is based on at least one piece of current location information of the at least one device, current status information of the at least one device, and function information of the at least one device.

25. The method of claim 23, wherein the location information is based on location information input by using the user terminal.

26. A computer readable recording medium storing a program for executing a method of providing an external device with information regarding at least one device, the method comprising:
receiving, from the external device, location information and service information; and
transmitting, to the external device, information regarding the at least one device capable of providing a service to the external device based on the service information in a predetermined region based on the location information.

27. An information-providing apparatus, comprising:
a communication unit for communicating with an external device; and
a processor for executing a program;
wherein the program comprises:
receiving, from the external device, location information and service information through the communication unit, and
transmitting, to the external device, information regarding at least one device capable of providing a service according to the service information in a predetermined region based on the location information, through the communication unit.

28. The apparatus of claim 27, wherein the information regarding the at least one device comprises at least one piece of current location information of the at least one device, current status information of the at least one device, and function information of the at least one device.

29. The apparatus of claim 27, wherein the information regarding the at least one device transmitted to the external device comprises at least one of map data and text data.

30. The apparatus of claim 27, wherein transmitting information regarding the at least one device capable of providing a service comprises finding the at least one device in the predetermined region based on previously stored information or by communicating with the at least one device using the communication unit.

31. The apparatus of claim 30, wherein the location information is based on location information input by using the external device.

32. The apparatus of claim 30, wherein the location information is based on location information input by using the external device.

33. A user terminal, comprising:
a user interface unit for interfacing with a user;
a communication unit for communicating with an external device; and
a processor for executing a program,
wherein the program comprises:
receiving, from the user interface unit, service information;
transmitting, to the external device, location information and the service information, through the communication unit;
receiving, from the external device, information regarding at least one device capable of providing a service based on the service information, through the communication unit; and
outputting the information regarding the at least one device to the user interface unit.

34. A service apparatus comprising:
a communication unit for communicating with an external device; and
a processor for executing a program,
wherein the program comprises:
receiving, from the external device, location information and service information, through the communication unit;
transmitting, to the external device, information regarding at least one device capable of providing a service according to the service information in a predetermined region based on the location information, through the communication unit;
receiving, from the external device, service selection information based on the transmitted information regarding the at least one device; and
controlling the at least one device capable of providing the service based on the service selection information through the communication unit.

35. A user terminal comprising:
a user interface unit for interfacing with a user; and
a processor for executing at least one program,
wherein the program comprises:
receiving, from the user interface unit, service information; and
outputting, to the user interface unit, information regarding at least one device capable of providing a service based on the service information in a predetermined region based on the location information.

36. The user terminal of claim 35, wherein the information regarding at least one device comprises at least one piece of current location information of the at least one device, current status information of the at least one device, and function information of the at least one device.

37. A user terminal comprising:
a user interface unit for interfacing with a user;
a communication unit for communicating with an external device; and
a processor for executing a program,
wherein the program comprises:
receiving, from the user interface unit, service information;
outputting, to the user interface unit, information regarding at least one device capable of providing a service based on the service information in a predetermined region based on the location information;
receiving, through the user interface unit, service selection information; and
controlling, through the communication unit, the at least one device capable of providing the service based on the received service selection information.
